(19) United States
(12) Patent Application Publication
(10) Pub. No.: US 2006/0133512 A1
(43) Pub. Date: Jun. 22, 2006

(54) Video decoder and associated methods of operation

(76) Inventor: Hyun-Sang Park, Cheonan-si (KR)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/200,015

(22) Filed: Aug. 10, 2005

(30) Foreign Application Priority Data
Dec. 16, 2004 (KR) 2004-106917

(51) Int. Cl. H04N 11/02; H04N 11/04; H04N 7/12; H04B 1/66

(52) U.S. Cl. 375/240.25; 375/240.24

(57) ABSTRACT

A video decoder and associated methods of operation are disclosed. The video decoder identifies groups of successive not-coded macro-blocks associated with a current frame in a bitstream of compressed video data received from a main memory. The video decoder then reads corresponding groups of macro-blocks associated with a previous frame from a first location in the main memory to a local memory and then back to a second location in the main memory in order to reconstruct the current frame.

### BACKGROUND OF THE INVENTION

1. Field of the Invention

The invention relates generally to a video decoder and associated methods of operation. More particularly, the invention relates to a motion-compensated video decoder adapted to transfer groups of not-coded macro-blocks between a main memory and a local memory.

2. Description of the Related Art

Video decoders are found in numerous electronic devices. For example, they are used to read digital video disks (DVDs), to process streaming media received from the internet, and to display video images on digital cameras, personal digital assistants (PDAs) and cellular phones, to name just a few common platforms.

A video decoder operates by receiving a video sequence in a compressed or encoded format and then transforming the video sequence into a decompressed or decoded format. In some cases, the encoded video sequence is provided through an input device coupled to an encoder. In other cases the encoded video sequence is read from a memory or received from a remote source, e.g., through a wireless or internet transmission.

The encoded video sequence may be presented to the decoder in one of any number of different encoding formats. For example, one of the most common ways of representing an encoded video sequence is as a collection of encoded units corresponding to small image regions. Each small image region, known as a “macro-block”, typically comprises a set of pixel values. For example, in a Moving Picture Experts Group (MPEG) encoded image, each macro-block typically comprises one 16×16 block of luminance values (Y) and two 8×8 blocks of corresponding chrominance values (UV). Alternatively, the pixel values may comprise red-green-blue (RGB) values, grayscale values, or some other form of digital image representation.

Each of the encoded units (hereafter, “macro-block unit”) corresponding to a macro-block comprises an encoded data element and an accompanying header. The encoded data element may include, for example, encoded pixel values, motion vectors used to estimate the motion of a macro-block between successive video frames, and/or an encoded “motion compensation error”, (i.e. a measure of how well the motion vectors predict macro-blocks between frames). The header generally provides information about the macro-block unit and/or its corresponding macro-block.

Although each macro-block typically comprises a 16×16 block of pixel values and two 8×8 blocks of pixel values, the pixel values are generally encoded in 8×8 blocks. For example, the 16×16 block of pixel values is typically encoded by performing a discrete cosine transform (DCT) on four (4) 8×8 blocks of pixel values, resulting in four 8×8 blocks of DCT coefficients.

The process of transforming encoded video into a decoded or decompressed format typically takes place through a series of sequential operations. The operations generally include interpreting the header of each macro-block unit, performing an inverse discrete cosine transform (IDCT) and motion compensation on some of the macro-block units, and performing image reconstruction and storage for macro-block units corresponding to the same image.

The operation of interpreting each header comprises reading information contained in the header and determining how to process the encoded data element based on this information. For example, where the header indicates that the macro-block unit was encoded without using motion estimation (e.g. when decoding an I-frame in MPEG decoding), the encoded data element will be decoded in a manner distinct from other cases where motion estimation was used.

The operation of performing an IDCT comprises transforming a set of DCT coefficient values in the encoded data element into a set of pixel values or motion estimation error values.

Subsequently, the operation of performing motion compensation comprises adding decoded motion compensation error values to reference data based on at least one macro-block from a previously decoded image. The location of the macro-block(s) in the previously decoded image(s) is defined by a motion vector in the macro-block header. In other words, a motion vector in macro-block header is used to locate macro-block(s) in previously decoded frame(s). Where the reference data is based on more than one macro-block (e.g., when decoding a B-frame in MPEG decoding), the more than one macro-blocks are combined, (e.g., by interpolation), to generate an interpolated macro-block. Where the reference data is not base on more than one macro-block, a non-interpolated macro-block is used. The interpolated or non-interpolated macro-block is then modified, or “compensated” to create a decoded macro-block by adding the decoded motion compensation error values thereto, and the resulting macro-block is used to reconstruct a current image.

In addition to the above described operations, a video decoder may further perform one or more of several additional operations including, for example, variable length decoding (e.g. Huffman decoding), inverse quantization, and so forth.

Some of the parameters related to the performance of a video decoder include its power consumption, bandwidth, compression ratio, information loss, memory requirement, and size.

Power consumption is an important parameter in video decoding because video decoders are frequently used in portable devices where battery life is limited. As a result, power efficient video decoders are desirable. In addition, excessive power consumption can cause electronic components to heat up, causing the components to wear out more quickly or even fail.

Bandwidth is another important parameter in video decoding because it can affect the effective frame rate and/or image quality that can be achieved by devices using the decoder. For example, an encoded video sequence having a particular frame-rate, resolution, and image quality can only be decoded by a video decoder capable of receiving, decoding, and transmitting the video sequence at a corresponding required bit-rate. Among other things, the bandwidth of a video decoder depends on its memory access speed, its storage capacity, clock rate, and so forth.

The compression ratio of a video decoder indicates the relative size of data received and produced by the video decoder. A higher compression ratio indicates a larger relative difference between the size of the data received and the size of the data produced by the decoder. A higher compression ratio is desirable for video decoders used in systems where memory is limited because it enables large video sequences to be produced from compact representations. In theory, there is no limit to the compression ratio that a video decoder can achieve, but practically speaking, the compression ratio is limited by a desired output video quality. Accordingly, video encoding techniques strive to produce compact encoded video sequences that preserve as much information from the corresponding original input video sequences as possible.

One such encoding technique involves comparing a current video frame with a previous video frame to determine whether portions of the two frames are the same, or in other words, whether parts of the video do not significantly change between the frames. In cases where a portion of the current and previous frames is the same, a macro-block corresponding to this portion may be designated as “not-coded” for the current frame. In other words, the macro-block is not stored in an encoded video sequence, but rather a header indicating that the macro-block is “not-coded” is included in the encoded video sequence. Then, in a subsequent decoding procedure a decoder uses a corresponding macro-block stored from a previous frame to reconstruct the current frame.

This technique is particularly effective in cases where a video sequence contains many stationary (i.e., non-changing) features. In such cases, a high degree of compression may be achieved without significantly sacrificing the video quality. In addition, using macro-blocks from a previous frame to reconstruct a current frame reduces the total number of macro-blocks that a decoder must decode in order to reconstruct the video sequence, thereby increasing the throughput of the video decoder. In sum, effectively increasing the compression ratio used by a decoder reduces the decoder's storage requirement and increases its speed.

Information loss occurs where an input video sequence is encoded in such a way that it can not be exactly reproduced by a decoder. Information loss may occur, for example, where an encoding procedure quantizes certain values to lower the number of bits needed to represent the video sequence. The information loss in such cases is typically proportional to the amount of quantization that takes place.

The memory requirement and size of a video decoder are also important parameters since video decoders are often used in portable or miniature devices. In such devices, it is generally desirable to have a small video decoder requiring very little memory since this reduces the amount of space required by the video decoder within the incorporating device.

FIG. (Fig.) 1 is a block diagram illustrating a conventional video decoder circuit. The video decoder circuit uses IDCT and motion compensation to decode a compressed bitstream representing a sequence of macro-blocks in a video sequence.

Referring to FIG. 1, a video decoder circuit 100 comprises a first local memory (LM0) 10, a second local memory (LM1) 12, a variable length decoder (VLD) 20, an inverse quantization/inverse discrete cosine transform (IQ/IDCT) unit 30, a video reconstruction unit 40, and a motion compensator 50. Video decoder circuit 100 is connected to a system memory 80 through a direct memory access (DMA) unit 60 and a system bus 70.

In FIG. 1, first local memory 10 stores the compressed bitstream and outputs the compressed bitstream to VLD 20. The compressed bitstream is generally fetched to first local memory 10 from system memory 80 via DMA unit 60 and system bus 70. VLD 20 performs variable length decoding on DCT coefficients and motion vectors represented by the bitstream. The decoded DCT coefficients are output to IQ/IDCT unit 30 and the decoded motion vectors are output to DMA unit 60.

IQ/IDCT unit 30 performs inverse quantization on the DCT coefficients and then performs an IDCT on the inverse quantized DCT coefficients. The inverse quantization procedure typically multiplies DCT coefficients by a set of quantization values used in a corresponding quantization procedure used to quantize the DCT coefficients. The IDCT procedure uses well known mathematical operations to transform a block of DCT coefficients into a set of pixel values or error values.

Second local memory 12 stores reference data used to perform motion compensation. The reference data typically comprises at least one macro-block from a previously decoded frame whose location in the previously decoded frame is defined by a motion vector in the compressed bitstream. The reference data may be fetched from system memory 80 using DMA unit 60 and system bus 70. That is, once DMA unit 60 receives the motion vector defining the location(s) of the macro-block(s) from the previously decoded frame(s), the corresponding reference data is fetched from system memory 80. The reference data is output to motion compensator 50, where it is processed before being output to video reconstruction unit 40. The processing that takes place in motion compensator 50 may include, for instance, combining information from more than one macro-block or producing the sub-integer unit pixel values by interpolating two or four neighboring pixels to form an averaged or interpolated macro-block.

MPEG encoding of a video sequence is one example of a video-encoding process in which a plurality of macro blocks are combined in a motion compensator. In MPEG encoding, a P-frame is encoded by combining information from a previous and a subsequent I-frame or P-frame selected from a sequence of frames. The previous and subsequent frames are encoded before the P-frame is encoded and decoded before the P-frame is decoded so that information from the I-frame(s) and/or P-frame(s) can be used to represent each macro-block in the P-frame.

In some cases, no information from a previously decoded frame is used to decode a current frame. For example in MPEG coding, an I-frame is encoded and decoded without reference to other frames. In these cases, the output of motion compensator 50 is not necessarily used to reconstruct a macro-block for a current frame. Otherwise, motion compensator 50 outputs an averaged or interpolated macro-block.

Video reconstruction unit 40 receives the macro-block output by motion compensator 50 and a set of corresponding pixel values or error values output by IQ/IDCT unit 30. In cases where the output of IQ/IDCT unit 30 comprises error values used for motion compensation, the error values are added to the corresponding motion-compensated macro-block output by motion compensator 50 and a resulting reconstructed macro-block is combined with other reconstructed macro-blocks to form a reconstructed current frame. In cases where IQ/IDCT unit 30 comprises a set of pixel values, e.g., in the case of decoding an I-frame, the pixel values may be combined with other sets of pixel values to form a reconstructed current frame. Once the reconstructed current frame is formed, it is output to DMA unit 60. Reconstructed frames output to DMA unit 60 are then stored in system memory 80 using system bus 70.

FIG. 2 is a time-wise chart showing an exemplary, ordered sequence of operations performed by a typical video decoder circuit 100. Throughout this description, method steps are designated within parentheses (XXX) to distinguish them from exemplary system elements, like those shown in FIG. 1.

Referring collectively to FIGS. 1 and 2, a compressed bitstream is stored in first local memory 10 by DMA unit 60 and output to VLD 20. VLD 20 then processes the compressed bitstream by decoding quantized DCT coefficients and motion vectors represented by the compressed bitstream (S11). The decoded quantized DCT coefficients are output to IQ/IDCT unit 30 and the decoded motion vectors are output to DMA unit 60.

Next, DMA unit 60 reads reference data to-be-used for motion compensation from system memory 80, wherein the reference data is based on a motion vector received from VLD 20 as described above (S12).

Motion compensator 50 then performs any necessary processing (e.g., interpolation) on the reference data and a resulting macro-block is output to video reconstruction unit 40 (S13).

Quantized DCT coefficients output by VLD 20 are inverse quantized and inverse discrete cosine transformed by IQ/IDCT unit 30 and then output to video reconstruction unit 40 (S14). Video reconstruction unit 40 then performs motion compensation by adding the macro-block output by motion compensator 50 to values output by IQ/IDCT unit 30 to generate a reconstructed macro-block used to generate final motion compensated video data (S15).

Once the final motion compensated video data is generated, the data is output to DMA unit 60 and stored in system memory 80 (S16). Operations S11 through S16 are repeated on several compressed bitstreams corresponding to macro-blocks of a video sequence until the video sequence is fully decoded.

Certain variations in the above described operations can be used to optimize various parameters related to the video decoder. For instance, as previously described, the amount of quantization can be increased or decreased in order to increase or decrease the compression ratio (and consequently the information loss) of the decoder. Nonetheless, the foregoing description serves to illustrate the general flow of a decoding operation, particularly in the context of an MPEG example.

One particular variation which may be used to increase the compression ratio of the decoder without significantly degrading the quality of the decoded video sequence involves a technique that takes advantage of the presence of “not-coded” macro-blocks. This technique is used where successive frames within a video sequence are substantially similar to one another, i.e., where there is little of no relative change or motion between successive frames. Where the motion vector corresponding to a particular macro-block is zero, the macro-block may be designated “not-coded”, i.e., an encoding procedure does not encode or compress the macro-block. Instead, a macro-block unit is generated, wherein the header of the macro-block unit designates the macro-block as “not-coded.” Within a subsequent decoding sequence, not-coded macro-blocks are defined by stored data corresponding to a macro-block at the same location in the previous frame, and this stored data is used as a substitute of sorts for the not-coded macro-block.

When video decoder circuit 100 processes a video sequence including “not coded” macro-blocks, VLD 20 interprets the header of each macro-block unit to determine if the corresponding macro-block was designated as not-coded. Where the corresponding macro-block was designated as not-coded, DMA unit 60 fetches a decoded macro-block previously stored in relation to a previous frame from system memory 80. As noted above, the location of this decoded macro-block from the previous frame is the same as the location of the “not-coded” macro-block in the current frame. The decoded macro-block thus read from system memory 80, stored in second local memory 12, and then written back to system memory 80 as part of the decoding process for the current frame.

FIG. 3 is a time-wise chart illustrating decoding operations performed in a situation wherein three (3) consecutive “not-coded” macro-blocks associated with a current frame are encountered by video decoder circuit 100. Referring to FIG. 3, a compressed bitstream from system memory 80 is stored in first local memory 10 through DMA unit 60. VLD 20 decodes the compressed bitstream and interprets the header of the corresponding macro-block unit. Upon interpreting the header of the macro-block unit, VLD 20 detects that the corresponding macro-block is designated not-coded. Accordingly, VLD 20 outputs a motion vector with a value of zero (0) to DMA unit 60 (S21).

DMA unit 60 fetches a decoded macro-block associated with a previous frame from a first location in system memory 80 in response to the motion vector output by VLD 20 and the decoded macro-block is then stored in second local memory 12 (S22). Once stored in second local memory 12, the decoded macro-block is written back to a designated second location in system memory 80 (S23).

As may be seen in FIG. 3, operations (S21), (S22), and (S23) are repeated for each one of not-coded macro-blocks “T−1”, “T”, and “T+1” in the current frame. Then, after not-coded macro-block “T+1” is decoded, a coded macro-block “T+2” is decoded using operations S11 through S16 described with reference to FIG. 2.

One drawback to the conventional method illustrated in FIG. 3 is that each not-coded macro-block in the encoded video sequence requires a separate memory access operation. Since each memory access operation requires a certain amount of power (depending on the size and capability of system memory 80), executing the large number of repetitive memory access operations associated with the method illustrated in FIG. 3 leads to excessive power consumption. In order to solve this problem, new methods of decoding video sequences and/or new video decoder architectures are needed.

### SUMMARY OF THE INVENTION

Recognizing the need to conserve power and increase speed in video decoder circuits, the present invention provides methods and devices adapted to decode video sequences in a time and energy efficient manner.

According to one embodiment of the invention, a method of operating a video decoder is provided. The method comprises determining successive not-coded macro-blocks in a sequence of macro-blocks associated with a current frame, defining a multiple macro-block DMA operation in relation to the successive not-coded macro-blocks, reading corresponding macro-blocks associated with a previous frame from a main memory in response to the multiple macro-block DMA operation, and writing the corresponding macro-blocks to the main memory.

According to another embodiment of the present invention, another method of operating a video decoder is provided. The method comprises sequentially identifying coded macro-blocks and not-coded macro-blocks in a sequence of macro-blocks associated with a current frame, wherein the not-coded macro-blocks comprise single not-coded macro-blocks and groups of successive not-coded macro-blocks; executing a decoding operation for each coded macro-block. The method further comprises executing a single macro-block DMA operation for each single not-coded macro-block; and executing a multiple macro-block DMA operation for each group of successive not-coded macro-blocks.

According to still another embodiment of the present invention, a method of operating a motion-compensation-based video decoder receiving a bitstream of compressed video data identifiable as a sequence of macro-blocks associated with a current frame is provided. The method comprises reading a corresponding previous frame macro-block from the main memory and writing a corresponding decoded macro-block to main memory for each macro-block in the sequence of macro-blocks, other than not-coded macro-blocks existing in a group of successive not-coded macro-blocks.

According to still another embodiment of the present invention, a motion-compensation-based video decoder is provided. The video decoder comprises a variable length decoder adapted to identify coded and not-coded macro-blocks in a sequence of macro-blocks associated with a current frame, a DMA circuit adapted to read a corresponding macro-block associated with a previous frame from a main memory in response to each coded macro-block, and a corresponding group of macro-blocks associated with the previous frame from the main memory in response to each group of successive not-coded macro-blocks.

### BRIEF DESCRIPTION OF THE DRAWINGS

The invention is described below in relation to several embodiments illustrated in the accompanying drawings. Throughout the drawings like reference numbers indicate like exemplary elements, components, or steps.

In the drawings:

FIG. 1 is a block diagram of a conventional video decoder circuit;

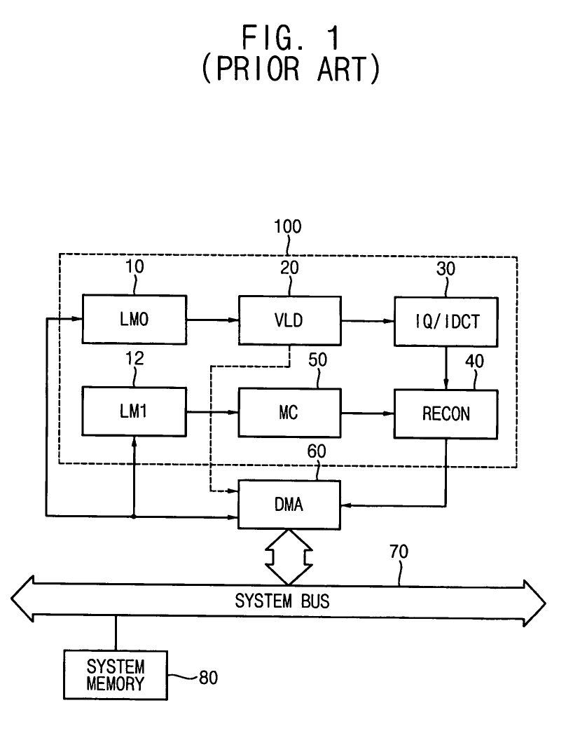

FIG. 2 is a chart illustrating a conventional method of decoding an encoded video sequence;

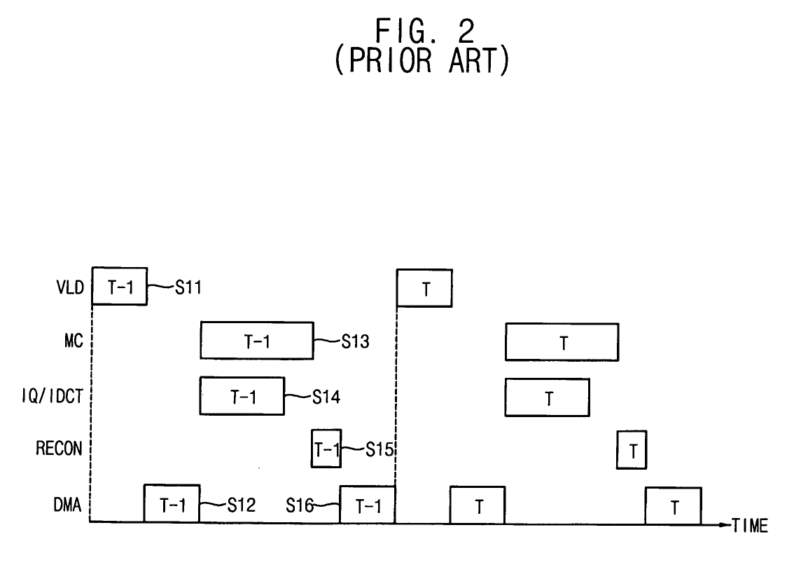

FIG. 3 is a chart illustrating a conventional method of decoding a series of successive “not-coded” macro-blocks;

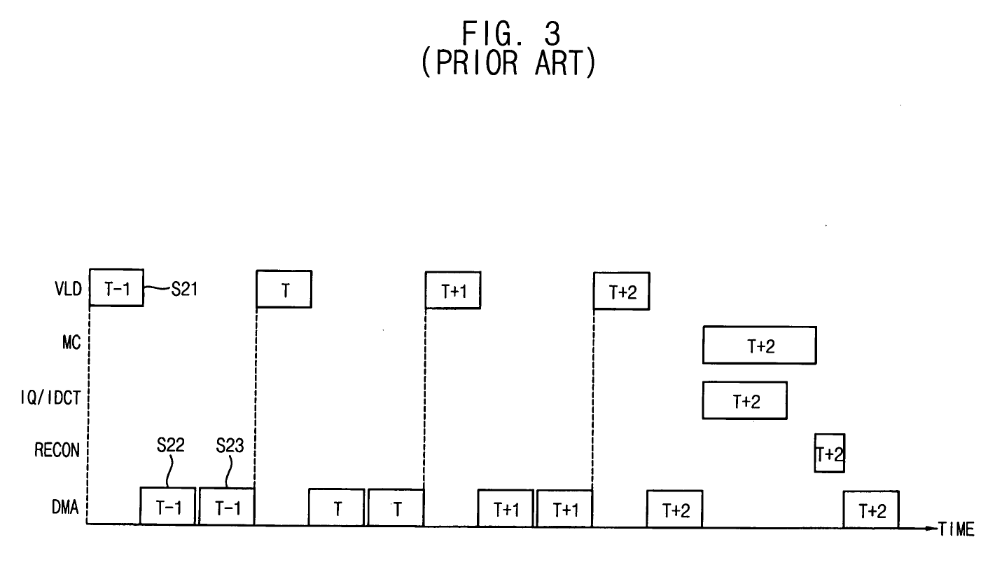

FIG. 4 is a chart illustrating a method of decoding a series of successive “not-coded” macro-blocks in accordance with one embodiment of the present invention;

FIG. 5 is a block diagram of a video decoder circuit in accordance with another embodiment of the present invention;

FIG. 6 is a block diagram of a video decoder circuit in accordance with still another embodiment of the present invention;

FIG. 7 is a block diagram of a video decoder circuit in accordance with still another embodiment of the present invention; and,

FIG. 8 is a chart showing a comparison of the average number of system memory access cycles per macro-block in a conventional video decoder circuit and a video decoder circuit according to the present invention.

### DESCRIPTION OF THE EXEMPLARY EMBODIMENTS

Exemplary embodiments of the invention are described below with reference to the corresponding drawings. These embodiments are presented as teaching examples. The actual scope of the invention is defined by the claims that follow.

The exemplary embodiments described below illustrate various methods of operating a video decoder to decode an encoded video sequence, whereby successive not-coded macro-blocks are transferred between a system memory and a local memory in groups, rather than being individually transferred. In addition, the exemplary embodiments illustrate various video decoders adapted to perform the various inventive methods.

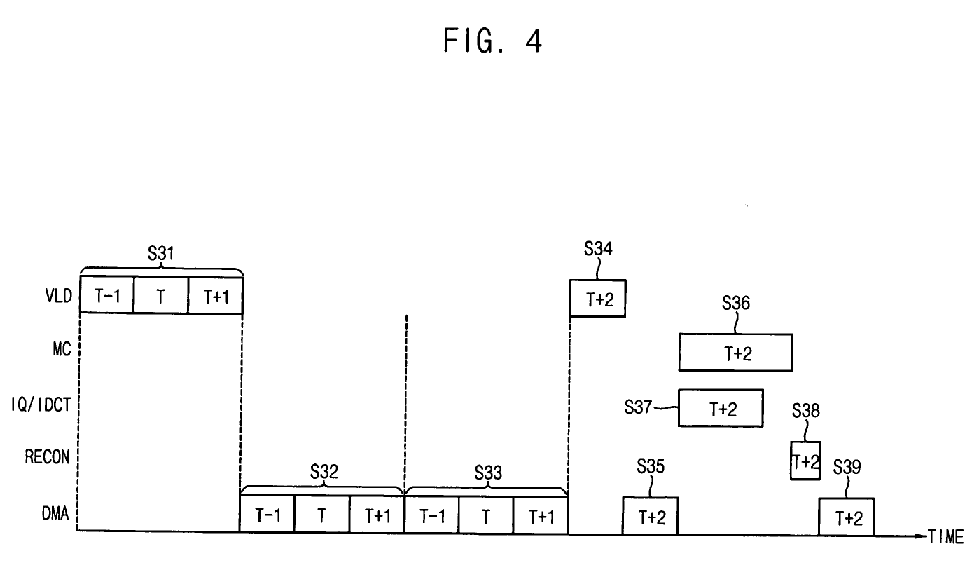

FIG. 4 is a time-wise chart illustrating a method of operating a video decoder to decode an encoded video sequence, wherein the video sequence includes a series of successive not-coded macro-blocks. In the encoded video sequence, each macro-block is represented by a compressed bitstream encoding a macro-block unit.

Each macro-block unit includes an encoded data element and an accompanying macro-block header. The encoded data element typically includes a coded block pattern (CBP) indicating whether each block of the macro-block is “coded” or “not-coded”. The blocks of macro-block information comprise, for example, pixel values or motion compensation error values etc. The macro-block header generally includes motion vector difference (MVD) and information about the CBP, and what quantization values (if any) were used.

Referring to FIG. 4, in an operation (S31), a compressed bitstream associated with a current frame is transferred from a system memory (i.e., a main memory) to a first local memory via a DMA unit. The compressed bitstream is output from the first local memory to a variable length decoder, where variable length decoding is performed on the bitstream to generate a macro-block unit. The variable length decoder inspects the macro-block header in the macro-block unit to determine whether the corresponding macro-block is not-coded. Upon determining that the corresponding macro-block is not-coded, the variable length decoder decodes subsequent bitstreams associated with the current frame and reads the corresponding macro-block headers to determine whether their corresponding macro-blocks are also not-coded. As seen in the example of FIG. 4, three (3) successive macro-blocks “T−1”, “T”, and “T+1” are not-coded.

Upon determining that multiple successive macro-blocks are not-coded, a multiple macro-block DMA operation is defined in relation to the successive not-coded macro-blocks. In this context, the DMA operation may identify, for example, a data block address for the data block to-be-read from system memory by the DMA unit, a horizontal and a vertical block size, and a horizontal resolution for the data block.

In an operation (S32), the DMA unit uses the data block address, the horizontal resolution, and the block sizes to read decoded macro-blocks stored in relation to a previous frame from a first location in the system memory to a second local memory. The decoded macro-blocks from the previous frame correspond to the successive not-coded macro-blocks associated with the current frame.

In order to prevent the DMA unit from prematurely accessing the system memory, a wait instruction may be issued to the DMA unit upon detecting that a first (or a next subsequent) compressed bitstream in a sequence of compressed bitstreams corresponds to a not-coded macro-block. Thus, in the context of the working example illustrated in FIG. 4, a DMA wait instruction may be issued upon determining that macro-block “T−1” is not-coded, and again upon determining that macro-block T in not-coded, and again upon determining that macro-block T+1 is not-coded. Thereafter, upon detecting a first coded macro-block following a sequence of not-coded macro-block will the DMA actually execute a read operation. Naturally, this wait while looking forward approach to DMA transfers will have practical temporal and bandwidth limitations, as defined within specific system architectures, but some useful aggregation of not-coded macro-blocks for purposes of DMA transfer is almost certainly possible.

In a step (S33), the decoded macro-blocks from the previous frame are written from the secondary local memory to a second location in the system memory. The decoded macro-blocks written to the system memory are thereafter used to reconstruct a decoded current frame.

By transferring groups (i.e., aggregations) of decoded macro-blocks between the system memory and the second local memory instead of transferring each macro-block individually, the total number of memory access cycles required by the overall decoding operation is markedly reduced. Accordingly, the operating speed of the video decoder is improved while associated power consumption is reduced.

DMA transfers associated with coded macro-blocks are handled along conventional lines. That is, a single macro-block DMA operation is performed per coded macro-block. The single macro-block DMA operation comprises reading reference data based on at least one previously decoded frame from a first location in the system memory, decoding the first macro-block by applying motion compensation to the reference data, and writing the decoded macro-block to a second location in the system memory. The reference data typically comprises one or two macro-blocks which may be taken from a previous I-frame or P-frame or a previous and next I-frame or P-frame, depending on whether the current frame is a P-frame or a B-frame.

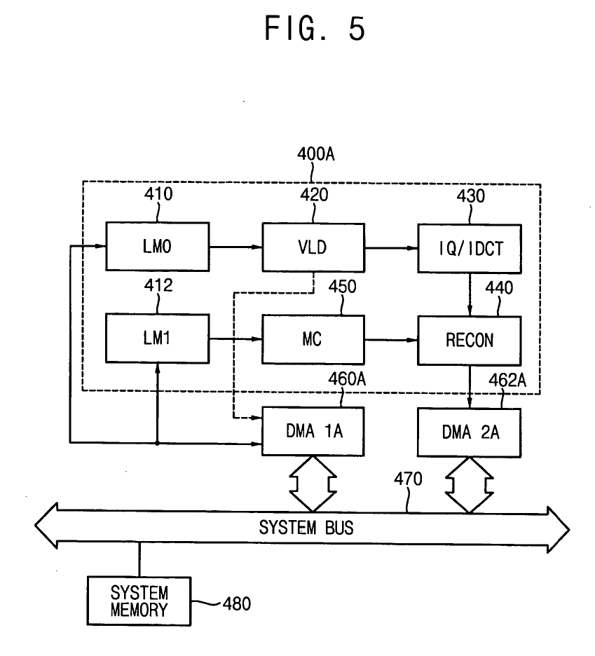

Exemplary methods contemplated in the context of the invention will find application in many specific system architectures. Three examples are illustrated in FIGS. 5 through 7.

FIG. 5 is a block diagram illustrating a video decoder circuit in accordance with one embodiment of the present invention. Referring to FIG. 5, the video decoder circuit comprises a first local memory 410, a second local memory 412, a VLD 420, an IQ/IDCT unit 430, a video reconstruction unit 440, and a motion compensator 450. The video decoder circuit further comprises a first DMA unit 460A and a second DMA unit 462A connected to a system memory 480 via a system bus 470.

VLD 420 identifies coded and not-coded macro-blocks in a sequence of macro-blocks associated with a current frame by processing a bitstream of compressed video data output by first local memory 410. The bitstream of compressed video data is output by first local memory 410.

For each coded macro-block identified by VLD 420, first DMA unit 460A reads a corresponding macro-block associated with a previous frame from system memory 480 to second local memory 412. In cases where the current frame is a B-frame, first DMA unit 460A also reads a corresponding previously decoded macro-block associated with a subsequent frame from the system memory 480 to the second local memory 412. Motion compensator 450 receives at least one decoded macro-block from second local memory 412, processes the at least one macro-block, and outputs a resulting macro-block to video reconstruction unit 440.

Video reconstruction unit 440 receives the macro-block output by the motion compensator 450 and performs motion compensation on the macro-block by adding motion compensation error values output by IQ/IDCT unit 430 thereto. A resulting motion compensated, decoded macro-block is then output by the video reconstruction unit 440 to the second DMA unit 462A, which then writes the motion compensated, decoded macro-block to system memory 480.

For each group of not-coded macro-blocks identified, first DMA unit 460A reads a corresponding group of macro-blocks associated with the previous frame from a first location in system memory 480 to second local memory 412. The group of macro-blocks is then written to a second location in system memory 480 via first DMA unit 460A.

As seen in FIG. 5, first DMA unit 460A is used to read compressed video data from the system memory 480 to the first local memory 410 and to read and write groups of successive non-coded macro-blocks between the system memory 480 and the second local memory 412. Second DMA unit 462A is used to write final decoded video data from video reconstruction unit 440 to system memory 480.

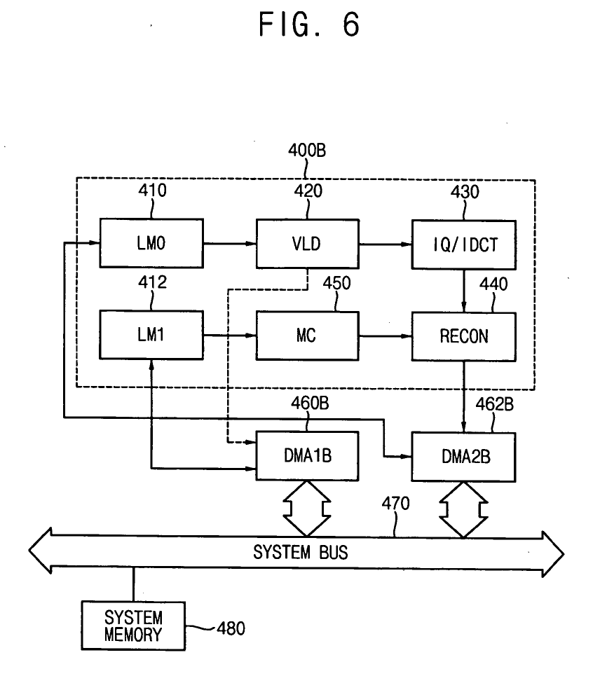

FIG. 6 is a block diagram illustrating a video decoder circuit in accordance with another embodiment of the present invention. Referring to FIG. 6, the video decoder circuit comprises a first local memory 410, a second local memory 412, a VLD 420, an IQ/IDCT unit 430, a video reconstruction unit 440, and a motion compensator 450. The video decoder circuit further comprises a first DMA unit 460B and a second DMA unit 462B connected to a system memory 480 via a system bus 470.

VLD 420 identifies coded and not-coded macro-blocks in a sequence of macro-blocks associated with a current frame by processing a bitstream of compressed video data output by first local memory 410. The bitstream of compressed video data is output by first local memory 410.

For each coded macro-block identified by VLD 420, first DMA unit 460B reads a corresponding macro-block associated with a previous frame from system memory 480 to second local memory 412. In cases where the current frame is a B-frame, first DMA unit 460B also reads a corresponding previously decoded macro-block associated with a subsequent frame from the system memory 480 to the second local memory 412. Motion compensator 450 receives at least one decoded macro-block from second local memory 412, processes the at least one macro-block, and outputs a resulting macro-block to video reconstruction unit 440. Video reconstruction unit 440 receives the macro-block output by the motion compensator 450 and performs motion compensation on the macro-block by adding motion compensation error values output by IQ/IDCT unit 430 thereto. A resulting motion compensated, decoded macro-block is then output by the video reconstruction unit 440 to the second DMA unit 462B, which then writes the motion compensated, decoded macro-block to system memory 480.

For each group of not-coded macro-blocks identified, first DMA unit 460B reads a corresponding group of macro-blocks associated with the previous frame from a first location in system memory 480 to second local memory 412. The group of macro-blocks is then written to a second location in system memory 480 via first DMA unit 460B.

Second DMA unit 462B is used to read compressed video data from system memory 480 to first local memory 410 and to write final decoded video data to system memory 480.

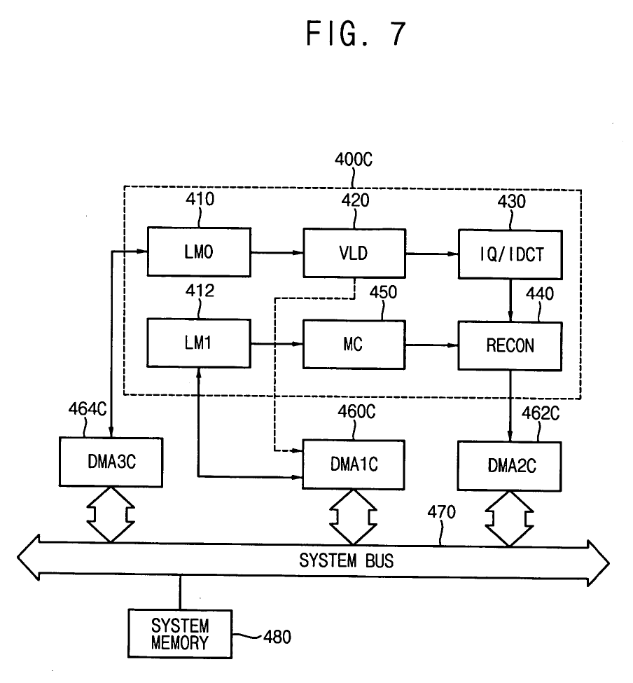

FIG. 7 is a block diagram illustrating a video decoder circuit in accordance with still another embodiment of the present invention. Referring to FIG. 7, the video decoder circuit comprises a first local memory 410, a second local memory 412, a VLD 420, an IQ/IDCT unit 430, a video reconstruction unit 440, and a motion compensator 450. The video decoder circuit further comprises a first DMA unit 460C, a second DMA unit 462C, and a third DMA unit 464C connected to a system memory 480 via a system bus 470.

VLD 420 identifies coded and not-coded macro-blocks in a sequence of macro-blocks associated with a current frame by processing a bitstream of compressed video data output by first local memory 410. The bitstream of compressed video data is output by first local memory 410.

For each coded macro-block identified by VLD 420, first DMA unit 460C reads a corresponding macro-block associated with a previous frame from system memory 480 to second local memory 412. In cases where the current frame is a B-frame, DMA unit 460C also reads a corresponding previously decoded macro-block associated with a subsequent frame from the system memory 480 to the second local memory 412. Motion compensator 450 receives at least one decoded macro-block from second local memory 412, processes the at least one macro-block, and outputs a resulting macro-block to video reconstruction unit 440.

Video reconstruction unit 440 receives the macro-block output by the motion compensator 450 and performs motion compensation on the macro-block by adding motion compensation error values output by IQ/IDCT unit 430 thereto. A resulting motion compensated, decoded macro-block is then output by the video reconstruction unit 440 to the second DMA unit 462C, which then writes the motion compensated, decoded macro-block to system memory 480.

For each group of not-coded macro-blocks identified, first DMA unit 460C reads a corresponding group of macro-blocks associated with the previous frame from a first location in system memory 480 to second local memory 412. The group of macro-blocks is then written to a second location in system memory 480 via first DMA unit 460C.

Second DMA unit 462C writes final decoded video data output by video reconstruction unit 440 to system memory 480 and third DMA unit 464C reads compressed video data from the system memory 480 to the first local memory 410.

The various DMA units shown in FIGS. 5 through 7 can be viewed as defining distinct physical components or more broadly, as distinct functional entities. For example, each illustrated DMA block element shown in FIGS. 5 through 7 may define a hardware or software partition, or simply a functional division of a single integrated unit. Using more than one DMA provides a number of possible benefits.

One benefit of using more than one DMA unit as shown in FIGS. 5 through 7 is that it allows a certain amount of pipelining to be implemented by the video decoder circuit. For example, using the video decoder circuit shown in FIG. 6, operations (S34) and (S39) shown in FIG. 4 may use second DMA unit 462B while operation (S35) may use first DMA unit 460B. Accordingly, operations (S34) and (S35) may be simultaneously performed on two successive macro-blocks associated with a current frame without creating a resource conflict.

Those of ordinary skill in the art will understand that there are various ways to divide the operations of the exemplary video decoders shown in FIGS. 5 through 7 into pipeline stages and to schedule corresponding decoding instructions according to the pipeline stages. Accordingly, an exhaustive presentation of particular pipelining principles, implementations, and mechanisms will not be presented herein.

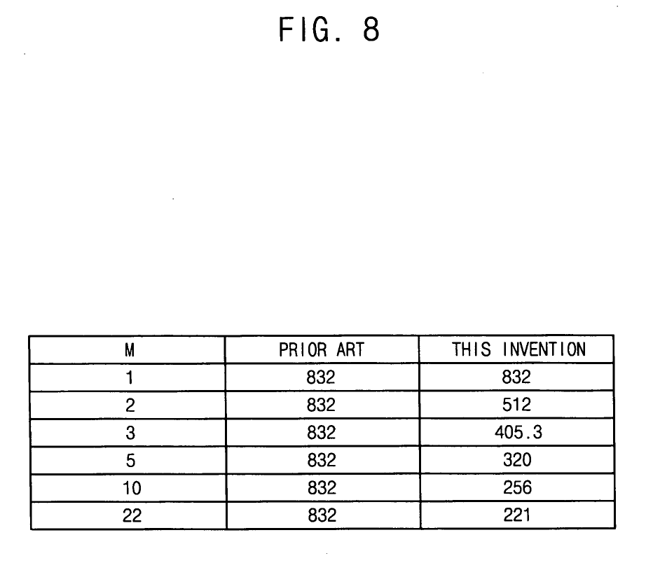

FIG. 8 is a data chart comparing an average number of system memory access cycles used to read and write macro-blocks between a system memory and a local memory in a conventional video decoder circuit with an average number of system memory access cycles used in a video decoder circuit according to an embodiment of the invention.

In FIG. 8, a column labeled “M” lists a number of successive not-coded macro-blocks in a video sequence. A column labeled “Conventional” shows an average number of system memory cycles required to read and write each of the “M” not-coded macro-blocks between a system memory and a local memory using a conventional video decoder circuit. A column labeled “Selected Embodiment” shows an average number of system memory cycles required to transfer the “M” not-coded macro-blocks from the system memory to a local memory using a video decoder circuit according to one embodiment of the present invention.

The chart of FIG. 8 assumes that the system memory comprises a DRAM with a row-access latency “L” of 10 cycles. It further assumes that each macro-block comprises a 16×16 block of 1-byte luminance values and two 8×8 blocks of 1-byte chrominance values. In each memory access operation, the system memory transfers a 4-byte word from the system memory to the local memory. Accordingly, the number of cycles required to transfer a row of the 16×16 luminance block between the system memory and the local memory using the conventional video decoder circuit is “L”+4 and the number of cycles required to transfer a row of an 8×8 chrominance block using the conventional video decoder circuit is “L”+2.

In contrast, the present invention allows multiple rows of each of the “M” macro-blocks to be read out together without incurring additional row access latency. Accordingly, the number of cycles required to transfer a row of the combined “M” macro-blocks between the system memory and the local memory is “L”+M×4 for the 16×16 luminance blocks and “L”+M×2 for the 8×8 chrominance blocks.

Thus, in order to read and write “M” macro-blocks using the conventional video decoder circuit, “M”×(16×(“L”+4) cycles are required to read the 16×16 luminance blocks and “M”×(16×(“L”+4) cycles are required to write the 16×16 luminance blocks back to memory. Similarly, reading and writing the “M” chrominance blocks requires 2×“M”×(8×(“L”+2)+8×(“L”+2)) cycles.

On the other hand, the video decoder according to the one selected embodiment of the invention only requires 16×(4×“M”+“L”) cycles to read the “M” 16×16 blocks and 16×(4×“M”+“L”) cycles to write the “M” 16×16 blocks. Likewise, the video decoder according to the one selected embodiment of the invention only requires 2×(8×(2×“M”+“L”)+8×(2×“M”+“L”)) cycles to read and write the “M” 8×8 chrominance blocks.

Because the video decoder circuit designed in accordance with the invention requires a significantly lower number of memory access cycles than the conventional video decoder circuit, in cases where large groups of not-coded macro-blocks are present, the video decoder circuit can provide better performance and better power efficiency than conventional video decoder circuits.

The results shown in FIG. 8 are exemplary of one selected embodiment of the invention as operating under the foregoing assumptions. Actual “access cycle” savings will be a function of the specific architecture of a system incorporating a video decoder designed in accordance with the invention. Nonetheless, significant access cycle savings are possible for any system running video decoding on a block by block basis, so long as some of said blocks are capable of being designated as “not-coded.”

The foregoing background and illustrative embodiments have been described in relation to systems assumed to be running MPEG related operations. MPEG is only a teaching context and the invention has broader applications across a spectrum of video decoding standards and techniques. Similarly, the specific use of terms like “local memory” and DMA” communicate broad functions of data transfer and storage. Any number and/or type of competent data storage and transfer elements may find application within systems incorporating the dictates of the invention.

What is claimed:

1. A method of operating a video decoder, comprising:
determining successive not-coded macro-blocks in a sequence of macro-blocks associated with a current frame;
defining a multiple macro-block DMA operation in relation to the successive not-coded macro-blocks;
reading corresponding macro-blocks associated with a previous frame from a main memory in response to the multiple macro-block DMA operation; and,
writing the corresponding macro-blocks to the main memory.

2. The method of claim 1, wherein determining the successive not-coded macro-blocks and defining the multiple macro-block DMA operation comprise:
reading a header associated with a first macro-block;
upon determining that the first macro-block is not-coded, reading a header associated with a next macro-block; and,
upon determining that the next macro-block is not-coded, defining the multiple macro-block DMA operation in relation to at least the first and next macro-blocks.

3. The method of claim 1, wherein the multiple macro-block DMA operation identifies in relation to the successive not-coded macro-blocks at least one of; memory address information, block size information, resolution information, and a READ/WRITE indication.

4. The method of claim 2, further comprising:
upon determining that the first macro-block is coded, executing a single macro-block DMA operation.

5. The method of claim 4, wherein the single macro-block DMA operation comprises:
reading a corresponding single macro-block associated with the previous frame from the main memory;
decoding the first macro-block and writing the decoded macro-block to the main memory.

6. The method of claim 2, further comprising:
upon determining that the first macro-block is not-coded, issuing a wait instruction to a DMA before reading the header associated with the next macro-block.

7. The method of claim 1, wherein reading the corresponding macro-blocks from the main memory and writing the corresponding macro-blocks to the main memory comprise:
reading the corresponding macro-blocks from a first memory location in the main memory and writing them to a first local memory; and thereafter,
reading the corresponding macro-blocks from the first local memory and writing them to a second memory location in the main memory.

8. The method of claim 7, further comprising:
storing a bitstream of compressed video data associated with the current frame in a second local memory; and,
decoding the stored bitstream of compressed video data in relation to the sequence of macro-blocks.

9. The method of claim 1, wherein the data area of the corresponding macro-blocks of the previous frame in the main memory associated with the multiple macro-block DMA operation is rectangular shape comprised of 16-lines, and the data of the corresponding macro-blocks of the previous frame is transferred from/to the main memory by “line by line” operation. (Plz add some comments in the detailed explanation part for supporting by specification)

10. A method of operating a video decoder, comprising:
sequentially identifying coded macro-blocks and not-coded macro-blocks in a sequence of macro-blocks associated with a current frame, wherein the not-coded macro-blocks comprise single not-coded macro-blocks and groups of successive not-coded macro-blocks;
executing a decoding operation for each coded macro-block;
executing a single macro-block DMA operation for each single not-coded macro-block; and
executing a multiple macro-block DMA operation for each group of successive not-coded macro-blocks.

11. The method of claim 10, wherein the multiple macro-block DMA operation comprises:
reading from a main memory a corresponding group of successive macro-blocks associated with a previous frame, and writing the corresponding group of successive macro-blocks to a local memory; and,
reading from the local memory the corresponding group of successive macro-blocks, and writing the corresponding group of successive macro-blocks to the main memory.

12. A method of operating a motion-compensation-based video decoder receiving a bitstream of compressed video data identifiable as a sequence of macro-blocks associated with a current frame, the method comprising:
reading a corresponding previous frame macro-block from a main memory and writing a corresponding decoded macro-block to the main memory for each macro-block in the sequence of macro-blocks, other than not-coded macro-blocks existing in a group of successive not-coded macro-blocks.

13. The method of claim 12, further comprising:
reading a corresponding group of previous frame macro-blocks from the main memory and writing the corresponding group of previous frame macro-blocks to the main memory for each group of successive not-coded macro-blocks

14. A motion-compensation-based video decoder, comprising:
a variable length decoder adapted to identify coded and not-coded macro-blocks in a sequence of macro-blocks associated with a current frame;
a DMA circuit adapted to read a corresponding macro-block associated with a previous frame from a main memory in response to each coded macro-block, and a corresponding group of macro-blocks associated with the previous frame from the main memory in response to each group of successive not-coded macro-blocks.

15. The motion-compensation-based video decoder of claim 14, further comprising a local memory adapted to receive a bitstream of compressed video data; and,
wherein the variable length decoder is further adapted to decode the bitstream of compressed video data as the sequence of macro-blocks.

16. The motion-compensation-based video decoder of claim 14 wherein the DMA circuit is further adapted to read a corresponding macro-block associated with the previous frame from the main memory in response to each single not-coded macro-block.

17. The motion-compensation-based video decoder of claim 14, wherein the variable length decoder is further adapted to identify whether each not-coded macro-block exists in a group of successive not-coded macro-blocks.

18. The motion-compensation-based video decoder of claim 17, wherein the variable length decoder is further adapted identify for each group of successive not-coded macro-blocks at least one of address location information, block size information, resolution information, and a READ/WRITE indication.

19. The motion-compensation-based video decoder of claim 14, wherein the DMA circuit comprises:
a first DMA unit and a second DMA unit adapted to transfer data to/from the main memory.

20. The motion-compensation-based video decoder of claim 19, further comprising:
a first local memory adapted to transfer data to the variable length decoder and a second local memory;
a motion compensator receiving data from the second local memory; and,
a video reconstruction circuit receiving data from the motion compensator and outputting decoded video data;
wherein the first DMA unit is adapted to transfer compressed video data from the main memory to the first local memory and to transfer groups of successive not-coded macro-blocks from the main memory to the second local memory; and,
wherein the second DMA unit is adapted to transfer the decoded video data from the video reconstruction circuit to the main memory.

21. The motion-compensation-based video decoder of claim 20, wherein the first DMA unit is further adapted to transfer a bitstream of compressed video data from the main memory to the second local memory as the sequence of macro-blocks.

22. The motion-compensation-based video decoder of claim 19, further comprising:
a first local memory adapted to transfer data to the variable length decoder, and a second local memory;
a motion compensator receiving data from the second local memory; and,
a video reconstruction circuit receiving data from the motion compensator and outputting decoded video data;
wherein the first DMA unit is adapted to transfer groups of successive not-coded macro-blocks from the main memory to the second local memory; and,
wherein the second DMA unit is adapted to transfer compressed video data from the main memory to the first local memory and to transfer the decoded video data from the video reconstruction circuit to the main memory.

23. The motion-compensation-based video decoder of claim 14, wherein the DMA circuit comprises a first DMA unit, a second DMA unit, and a third DMA unit adapted to transfer data to/from the main memory, and wherein the video decoder further comprises:
a first local memory adapted to transfer data to the variable length decoder, and a second local memory;
a motion compensator receiving data from the second local memory; and,
a video reconstruction circuit receiving data from the motion compensator and outputting decoded video data;
wherein the first DMA unit is adapted to transfer groups of successive not-coded macro-blocks from the main memory to the second local memory;
wherein the second DMA unit is adapted to transfer the decoded video data from the video reconstruction circuit to the main memory; and,
wherein the third DMA unit is adapted to transfer compressed video from the main memory to the first local memory.
